(19) United States
(12) Patent Application Publication
(10) Pub. No.: US 2014/0210650 A1
(43) Pub. Date: Jul. 31, 2014

(54) APPARATUS AND METHOD FOR INFORMING BUS DRIVER OF INTENTION TO GET ON OR OFF BUS

(71) Applicant: Electronics and Telecommunications Research Institute, Daejeon-city (KR)

(72) Inventors: Do-Hyung KIM, Daejeon (KR); Jae-Ho Lee, Daejeon (KR); Choong-Bum Park, Daejeon (KR); Jin-Suk Ma, Daejeon (KR); Cheol Ryu, Daejeon (KR); Seok-Jin Yoon, Daejeon (KR); Hyung-Seok Lee, Daejeon (KR)

(73) Assignee: Electronics and Telecommunications Research Institute, Daejeon-city (KR)

(21) Appl. No.: 13/958,344

(22) Filed: Aug. 2, 2013

(30) Foreign Application Priority Data
Jan. 29, 2013 (KR) 10-2013-0009612

(51) Int. Cl. G08G 1/123

(52) U.S. Cl. CPC G08G 1/123
USPC 340/994

(57) ABSTRACT

Disclosed herein are an apparatus and method for informing a bus driver of a user's intention to get on or off a bus. The apparatus for informing a bus driver of a user's intention to get on or off a bus includes a getting-on information collection device. The getting-on information collection device includes a getting-on information reception unit, an arrival-expected bus identification unit, and a transmission information transmission unit. The getting-on information reception unit receives getting-on information entered by a passenger who desires to get on a bus at a bus stop via a getting-on information transfer device of the bus stop. The arrival-expected bus identification unit identifies a bus expected to arrive having the earliest expected arrival time at the bus stop based on a bus number. The transmission information transmission unit transmits the transmission information to the getting-on information notification device of the bus expected to arrive.

### CROSS REFERENCE TO RELATED APPLICATION

This application claims the benefit of Korean Patent Application No. 10-2013-0009612, filed on Jan. 29, 2013, which is hereby incorporated by reference in its entirety into this application.

### BACKGROUND OF THE INVENTION

1. Technical Field

The present invention relates generally to an apparatus and method for informing a bus driver of a user's intention to get on or off a bus and, more particularly, to an apparatus and method for informing a bus driver of a user's intention to get on or off a bus, which enable the user to safely get on a bus at a bus stop and get off the bus at a desired destination bus stop using a mobile terminal equipped with a data transmission function and a wireless reception device provided in each of the bus stops.

2. Description of the Related Art

Currently, a user can be aware of the expected arrival time of a desired bus at a bus stop in advance using a monitor or a smart phone application via a traffic information system. Meanwhile, in order to get on a bus, when the bus approaches a bus stop, a user informs a bus driver of his or her intention to get on the bus. In this case, the intention to get on the bus may correspond to, for example, the action of standing up and waving his or her hand. Furthermore, after getting on the bus, the user should press a getting-off button in the bus when the bus approaches a destination bus stop. That is, this method requires that specific actions should be taken when a user gets on and off a bus. Furthermore, there may occur a case where a bus may pass a corresponding bus stop unless a user takes an appropriate action in time when the bus approaches the bus stop.

In connection with this, there is a technology that is disclosed in Korean Patent No. 1183832 entitled “Method for Waiting Passenger Notification Service.”

### SUMMARY OF THE INVENTION

Accordingly, the present invention has been made keeping in mind the above problems occurring in the conventional art, and an object of the present invention is to provide an apparatus and method for informing a bus driver of a user's intention to get on or off a bus, which enable the user to safely get on a bus at the bus stop and get off at a desired destination bus stop without requiring the separate action of informing a bus driver of his or her intention to get on and off the bus, using a mobile terminal equipped with a data transmission function and a wireless reception device provided in each of the bus stops.

According to an aspect of the present invention, there is provided a getting-on information collection device, including a getting-on information reception unit configured to receive getting-on information entered by a mobile terminal of a passenger who desires to get on a bus at a bus stop via a getting-on information transfer device of the bus stop; an arrival-expected bus identification unit configured to identify a bus expected to arrive having an earliest expected arrival time at the bus stop based on a bus number included in the getting-on information, and to generate transmission information to be transmitted to the bus expected to arrive; and a transmission information transmission unit configured to transmit the transmission information to a getting-on information notification device of the bus expected to arrive.

The getting-on information notification device may calculate the number of passengers who will get off at the bus stop based on transmission information corresponding to a plurality of bus stops that the bus has passed before arriving at the bus stop.

The arrival-expected bus identification unit may calculate the number of passengers who will get on at the bus stop based on the getting-on information of passengers received from the getting-on information transfer device.

If a size of the getting-on information is equal to or smaller than preset bytes, the mobile terminal may include the getting-on information in a management frame used to set up communication, and then transmit the management frame to the getting-on information transfer device.

The management frame may include a Media Access Control (MAC) header, a frame body including the getting-on information, a Frame Check Sequence (FCS) and Cyclic Redundancy Check (CRC).

The transmission information may include the number of passengers who will get on at the bus stop, information about the destinations of the passengers, and the ID of the bus stop.

The getting-on information notification device informs a bus driver of a number of persons who will get on or off at the bus stop based on the transmission information.

According to another aspect of the present invention, there is provided a getting-on information notification device, including a transmission information reception unit configured to receive a plurality of pieces of transmission information of a plurality of bus stops generated by a getting-on information collection device based on getting-on information entered by mobile terminals of passengers; a number-of-changing passengers calculation unit configured to calculate a number of passengers who will get on or off at a bus stop having the earliest expected arrival time among the plurality of bus stops based on the plurality of pieces of transmission information; and a number-of-changing passengers display unit configured to display the number of passengers who will get on or off.

The number-of-changing passengers calculation unit may classify the destination information of passengers included in the plurality of pieces of transmission information, and may calculate the number of passengers who will get off at each of the plurality of bus stops.

The plurality of pieces of transmission information may include the numbers of passengers who will get on at the plurality of bus stops, the destination information of the passengers, and the IDs of the plurality of bus stops.

The number-of-changing passengers display unit may include at least one of a display and a speaker.

According to still another aspect of the present invention, there is provided a mobile terminal, including an input unit configured to receive getting-on information including the bus number of a bus that a user will get on and destination information from the user; a validity determination unit configured to determine whether the getting-on information is valid; and a terminal communication unit configured to transmit the getting-on information to the getting-on information transfer device of a bus stop.

The validity determination unit may include the getting-on information in a management frame used to set up communication if a size of the getting-on information is equal to or smaller than preset bytes; and the terminal communication unit may transmit the management frame to the getting-on information transfer device.

The management frame may include an MAC header, a frame body including the getting-on information, an FCS and an CRC.

The validity determination unit may determine whether the getting-on information is valid by checking whether the destination information is present in the bus route information of the bus number.

If the getting-on information is not valid, the validity determination unit requests the user to enter getting-on information again.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating an apparatus for informing a bus driver of a user's intention to get on or off a bus according to an embodiment of the present invention;

FIG. 2 is a block diagram of the mobile terminal included in the apparatus for informing a bus driver of a user's intention to get on or off a bus according to the embodiment of the present invention;

FIG. 3 is a block diagram of the getting-on information collection device included in the apparatus for informing a bus driver of a user's intention to get on or off a bus according to an embodiment of the present invention;

FIG. 4 is a block diagram of the getting-on information notification device included in the apparatus for informing a bus driver of a user's intention to get on or off a bus according to the embodiment of the present invention;

FIG. 5 is a diagram illustrating an example of the display of the getting-on information notification device included in the apparatus for informing a bus driver of a user's intention to get on or off a bus according to the embodiment of the present invention;

FIG. 6 is a flowchart illustrating a method of informing a driver of a user's intention to get on or off a bus according to an embodiment of the present invention;

FIG. 7 is a flowchart illustrating a method that is performed in the mobile terminal according to an embodiment of the present invention;

FIG. 8 is a flowchart illustrating a method that is performed in the getting-on information collection device according to an embodiment of the present invention; and

FIG. 9 is a flowchart illustrating a method that is performed in the getting-on information notification device according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

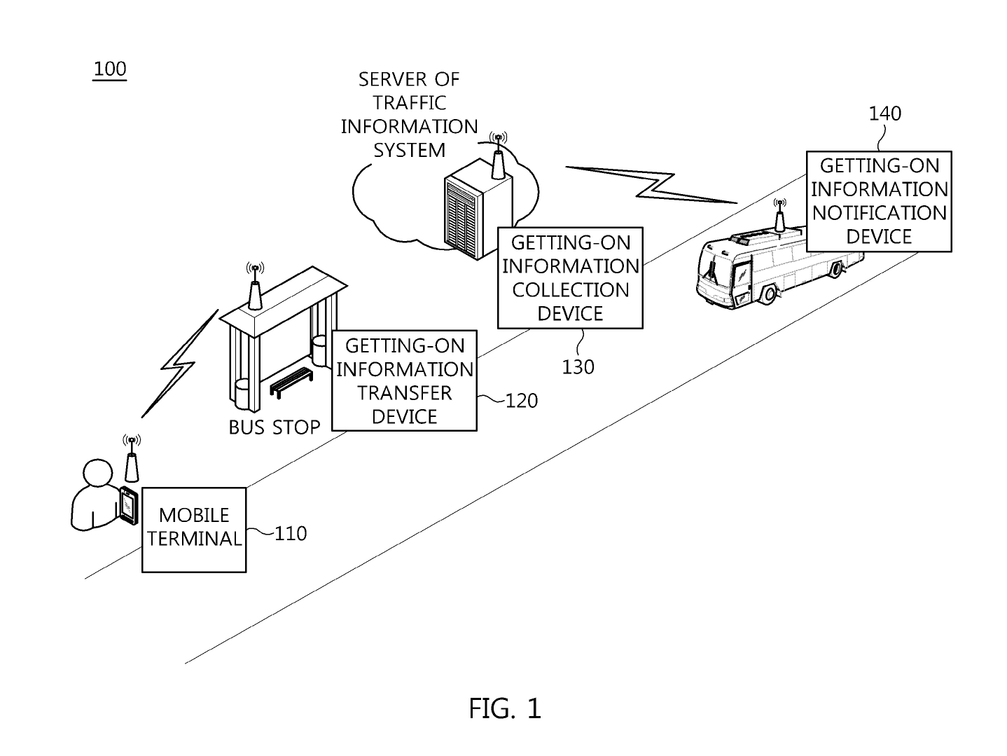

An apparatus 100 for informing a bus driver of a user's intention to get on or off a bus according to an embodiment of the present invention will be described below with reference to FIG. 1. FIG. 1 is a conceptual diagram illustrating the apparatus 100 for informing a bus driver of a user's intention to get on or off a bus according to this embodiment of the present invention.

As illustrated in FIG. 1, the apparatus 100 for informing a bus driver of a user's intention to get on or off a bus according to this embodiment of the present invention includes a mobile terminal 110, a getting-on information transfer device 120, a getting-on information collection device 130, and a getting-on information notification device 140. Individual components included in the apparatus 100 for informing a bus driver of a user's intention to get on or off a bus according to this embodiment of the present invention will be described below.

First, the mobile terminal 110 receives getting-on information from a user. In this case, the getting-on information is information about the bus number of a bus that the user desires to get on and a destination. Thereafter, the mobile terminal 110 determines whether the getting-on information received from the user is valid. The determination of the validity is performed by checking whether the user can get on a bus of the number received from the user at a bus stop where the user is currently located and checking whether the destination is included in the bus route of the corresponding bus number. In this case, if the getting-on information is invalid, the user is prompted to enter getting-on information again, thereby causing valid getting-on information to be entered. If the getting-on information received from the user is valid, the above-described getting-on information is transmitted to the getting-on information transfer device 120. In this case, a method of communication between the mobile terminal 110 and the getting-on information transfer device 120 will be described below.

If a size of the getting-on information is equal to or smaller than preset bytes, the mobile terminal 110 includes the getting-on information in a management frame that is used to set up communication. In this case, a management frame is one of the frames that are exchanged in communication between the mobile terminal 110 and the getting-on information transfer device 120. In this case, the frames are classified into three types: control frames, management frames, and data frames. The control frames are used for the Media Access Control (MAC) control of a wireless channel such as ACK and RTS. The management frames are used for the management of the apparatus, such as a beacon, the setup of a connection, and authentication. The data frames are the units of information that is transmitted in single blocks or packets. Furthermore, a management frame includes a MAC header, a frame body including getting-on information, a Frame Check Sequence (FCS) and Cyclic Redundancy Check (CRC). Accordingly, if a size of the getting-on information is equal to or smaller than preset bytes is included, the getting-on information can be communicated between the mobile terminal 110 and the getting-on information transfer device 120 without requiring the setup of a separate network.

In contrast, if the size of the getting-on information is not equal to or smaller than the preset bytes, a network is set up, and then the getting-on information is transmitted between the mobile terminal 110 and the getting-on information transfer device 120.

The getting-on information transfer device 120 waits to receive getting-on information from the mobile terminal 110. Thereafter, when getting-on information is transmitted by the mobile terminal 110, the getting-on information transfer device 120 receives the getting-on information. In this case, when the getting-on information transfer device 120 receives a management frame from the mobile terminal 110, it reads getting-on information from the management frame. Thereafter, the getting-on information transfer device 120 transmits the read getting-on information to the getting-on information collection device 130.

The getting-on information collection device 130 receives the getting-on information from the getting-on information transfer device 120 first. Thereafter, the getting-on information collection device 130 identifies a bus having the earliest expected arrival time at the bus stop based on a bus number included in the received getting-on information. Furthermore, the getting-on information collection device 130 may determine the number of passengers based on the number of pieces of getting-on information that are transmitted by the getting-on information transfer device 120. Thereafter, the getting-on information collection device 130 generates transmission information to be transmitted to a bus expected to arrive. In this case, the transmission information includes the number of persons who will get on at the bus stop, information about the destinations of the persons, and the ID of the bus stop. Thereafter, the getting-on information collection device 130 transmits the generated transmission information to the getting-on information notification device 140 of the bus expected to arrive.

The getting-on information notification device 140 receives the transmission information from the getting-on information collection device 130 first. The getting-on information notification device 140 may determine the number of passengers who will get on at the bus stop based on the received transmission information. Furthermore, the getting-on information notification device 140 calculates the number of passengers who will get off at the bus stop based on transmission information corresponding to a plurality of bus stops that the bus expected to arrive has passed before arriving at the bus stop. Thereafter, the getting-on information notification device 140 informs the driver of the bus of the number of passengers who will get on stored in transmission information and the calculated number of passengers who will get off.

In the description given with reference to FIG. 1, the number of passengers who will get on at the bus stop has been described as being calculated by the getting-on information collection device 130, and the number of passengers who will get off at the bus stop has been described as being calculated by the getting-on information notification device 140. However, it should be appreciated that in order to reduce the burden of the getting-on information collection device 130, the getting-on information notification device 140 may calculate both the number of passengers who will get on and the number of passengers who will get off.

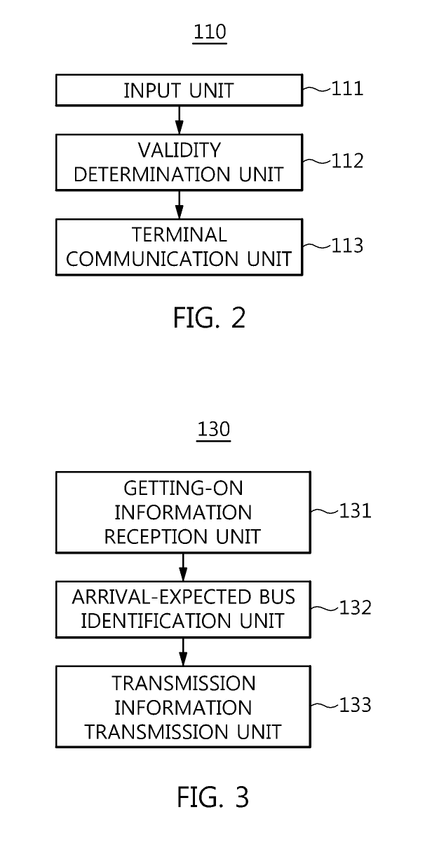

The mobile terminal 110 will be described in greater detail below with reference to FIG. 2. FIG. 2 is a block diagram of the mobile terminal 110. As illustrated in FIG. 2, the mobile terminal 110 includes an input unit 111, a validity determination unit 112, and a terminal communication unit 113. Individual components included in the mobile terminal 110 will be described below.

The input unit 111 receives the bus number of a bus that the user will get on and destination information from the user. In this case, the bus number and the destination information will be referred to as “getting-on information” for the purposes of the clarity of the specification.

The validity determination unit 112 determines whether the getting-on information received from the user is valid. The determination of the validity may be performed by comparing the bus route corresponding to the bus number with the destination of the passenger. That is, if the destination of the passenger is not included in the bus route corresponding to the bus number, it may be determined that the passenger has entered invalid getting-on information. Such bus route information may be stored and managed in a separate database. If it is determined that the invalid getting-on information has been entered, the validity determination unit 112 informs the user that the invalid getting-on information has been entered and then requests the user to enter valid getting-on information. Meanwhile, if it is determined that valid getting-on information has been entered, the validity determination unit 112 transfers control to the terminal communication unit 113. Furthermore, if a size of the getting-on information is equal to or smaller than preset bytes, the validity determination unit 112 stores the getting-on information in a management frame that is used to set up communication. Since the description of the management frame has been already described with reference to FIG. 1, a description thereof will be omitted.

The terminal communication unit 113 functions to transmit the getting-on information to the getting-on information transfer device 120 of the bus stop. In this case, communication with the getting-on information transfer device 120 may be directly performed without setting up a separate network if getting-on information is transferred in a management frame, as described above.

The getting-on information collection device 130 will be described in greater detail with reference to FIG. 3. FIG. 3 is a block diagram of the getting-on information collection device 130. As illustrated in FIG. 3, the getting-on information collection device 130 includes a getting-on information reception unit 131, an arrival-expected bus identification unit 132, and a transmission information transmission unit 133. Individual components included in the getting-on information collection device 120 will be described below.

The getting-on information reception unit 131 functions to receive the getting-on information transmitted by the getting-on information transfer device 120. Such getting-on information may be stored in a separate database or in the server of a traffic information system. The stored getting-on information may be used to manage bus getting-on information for each bus route or each time later.

The arrival-expected bus identification unit 132 functions to identify a bus expected to arrive, which has the earliest expected arrival time at bus stop. This identification may be performed based on information about buses that arrive at the bus stop. Such bus information may be stored in a separate database the server of a traffic information system.

Furthermore, arrival-expected bus identification unit 132 functions to calculate the number of passengers who will get on at the bus stop. In this case, the number of passengers may be calculated based on the number of pieces of getting-on information transmitted by the getting-on information transfer device 120.

Furthermore, the arrival-expected bus identification unit 132 functions to generate transmission information to be transmitted to the bus expected to arrive. In this case, the transmission information is information that is used to calculate the number of persons who will get on or off at the bus for each bus stop. Such transmission information includes the number of persons who will get on, information about the destinations of the persons, and the ID of the bus stop, as described above.

The transmission information transmission unit 133 functions to transmit the transmission information generated by the arrival-expected bus identification unit 132 to the getting-on information notification device 140 of the bus expected to arrive.

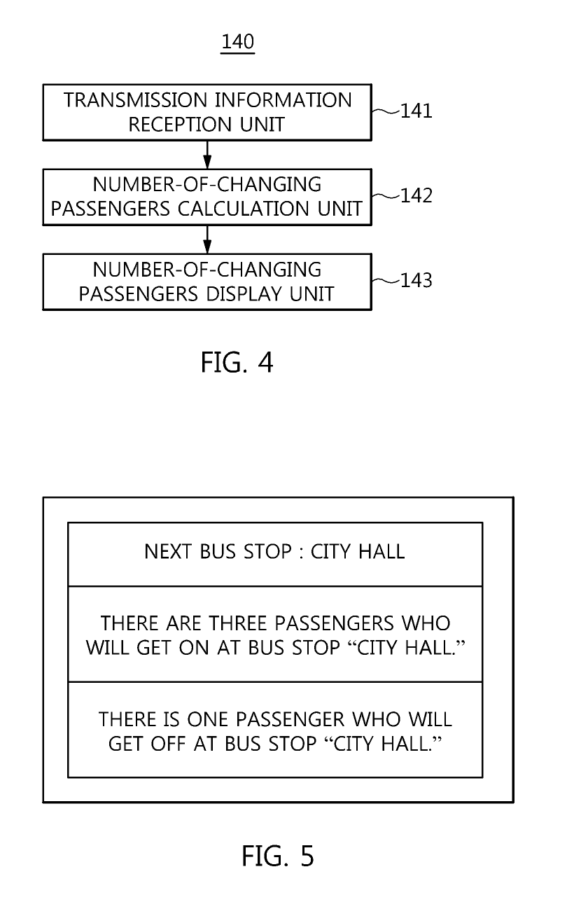

The getting-on information notification device 140 will be described in greater detail with reference to FIGS. 4 and 5. FIG. 4 is a block diagram of the getting-on information notification device 140. As illustrated in FIG. 4, the getting-on information notification device 140 includes a transmission information reception unit 141, a number-of-changing passengers calculation unit 142, and a number-of-changing passengers display unit 143. Individual components included in the getting-on information collection device 120 will be described below.

The transmission information reception unit 141 functions to receive transmission information from the getting-on information collection device 130. In this case, the transmission information is used to calculate the number of passengers who will get on or off, as described above.

The number-of-changing passengers calculation unit 142 may determine the number of passengers who will get on at the bus stop based on the number of persons who will get on, which is included in the transmission information. Furthermore, the number-of-changing passengers calculation unit 142 calculates the number of passengers who will get off at the bus stop based on transmission information corresponding to a plurality of bus stops that the bus expected to arrive has passed before arriving the bus stop. In greater detail, the number-of-changing passengers calculation unit 142 classifies the destination information of passengers in the bus based on transmission information transmitted from a plurality of bus stops, and calculates the number of passengers who will get off at each of the bus stops.

The number-of-changing passengers display unit 143 displays the number of persons who will get off or on, which is calculated by the number-of-changing passengers calculation unit 142. The number-of-changing passengers display unit 143 may include at least one of a display and a speaker. Accordingly, the number-of-changing passengers display unit 143 may use a display and a voice in order to display the number of persons who will get off or on. An example of the display of the number-of-changing passengers display unit 143 is illustrated in FIG. 5. As illustrated in FIG. 5, a displayed screen displays bus stop information and the number of persons who will get on or off at the bus stop. Furthermore, bus stop information and the number of persons who will get on or off at a bus stop may be output in the form of voice. A bus driver can determine whether the number of persons who will get on or off at the bus stop the above information.

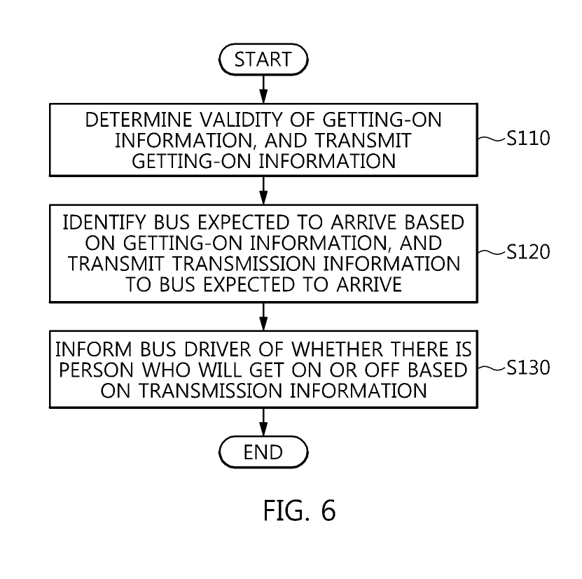

A method of informing a driver of a user's intention to get on or off a bus according to an embodiment of the present invention will be described with reference to FIG. 6. FIG. 6 is a flowchart illustrating the method of informing a driver of a user's intention to get on or off a bus according the embodiment of the present invention. In the following description, redundant descriptions will be omitted for the purposes of the clarity of the specification.

First, the mobile terminal determines the validity of getting-on information that is entered by a user and transmits the getting-on information at step S110. In this case, the getting-on information means the bus number of a bus that the user desires to get on and destination information, as described above. The determination of the validity performed at step S110 is performed by checking if the user can get on a bus of the bus number received from the user at the bus stop where the user is currently located and if the destination is included in a bus route. If, as a result of the determination of the validity at step S110, it is determined that the getting-on information entered by the user is invalid, the user is requested to enter getting-on information again. This step may be repeated until valid getting-on information is input. If it is determined at step S110 that valid getting-on information has been entered, the getting-on information is transmitted to the getting-on information transfer unit. Thereafter, control is transferred to step S120.

Thereafter, the getting-on information collection device identifies a bus expected to arrive based on the transmitted getting-on information and transmits transmission information to the bus expected to arrive at step S120. In this case, the bus expected to arrive is a bus having the earliest expected arrival time at the bus stop. This identification is performed based on a bus number included in the getting-on information. That is, a bus that has the earliest expected arrival time among buses having the bus number desired by the user is identified as the bus expected to arrive. Thereafter, the transmission information is generated at step S120. In this case, the transmission information includes the number of passengers who will get on at the bus stop, information about the destinations of the persons, and the ID of the bus stop, as described above. Thereafter, the transmission information is transmitted to the getting-on information notification device 140 of the bus expected to arrive, and control is transferred to step S130.

At step S130, the getting-on information notification device informs the driver of there is a person who will get on or/and off at the bus stop based on the transmitted transmission information. In this case, the getting-on information notification device may determine the number of persons who will get on at the bus stop based on the transmission information. At step S130, the number of passengers who get off at the bus stop is calculated based on transmission information corresponding to a plurality of bus stops that the bus expected to arrive has passed before arriving the bus stop. Thereafter, at step S130, a driver is informed of the number of persons who will get on and the number of persons who will get off.

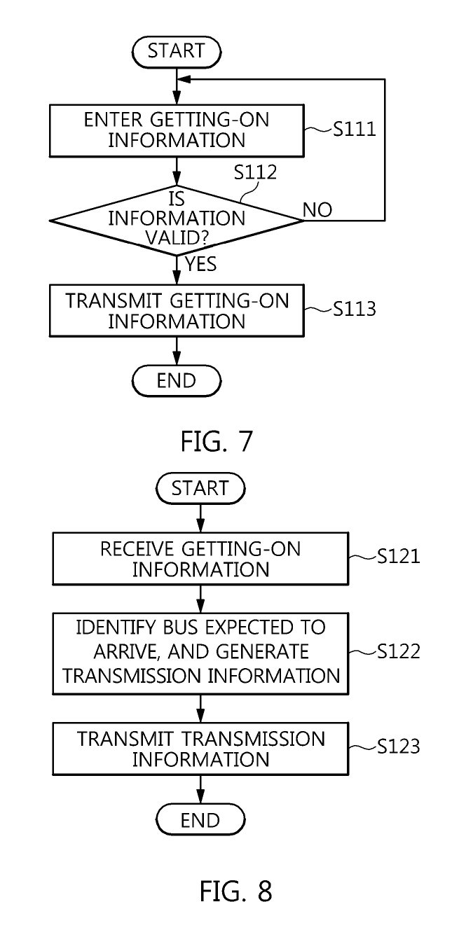

A process that is performed in the mobile terminal will be described with reference to FIG. 7. FIG. 7 is a flowchart illustrating a method that is performed in the mobile terminal according to an embodiment of the present invention.

First, getting-on information is received from a user at step S111. A method of input at step S111 may be a conventional method that has been known or a method that will be known.

Thereafter, whether the getting-on information entered by the user is valid is determined at step S112. The determination at step S112 may be performed by comparing a bus route corresponding to a bus number with the destination of the passenger, as described above. That is, if the destination of the passenger is not included in a bus route corresponding to the bus number, it may be determined that the passenger has entered invalid getting-on information. If it is determined at step S112 that the getting-on information entered by the user is invalid, control is transferred at step S111. Thereafter, the user is requested to enter getting-on information again, and this step is repeated until valid getting-on information is entered. In contrast, if it is determined at step S112 that the getting-on information entered by the user is valid, the step of determining whether a size of the getting-on information is equal to or smaller than preset bytes is additionally performed. In this case, if a size of the getting-on information is equal to or smaller than preset bytes, the getting-on information is included in a management frame that is used to set up communication. If the getting-on information is included in the management frame and then transmitted, communication may be performed without setting up a separate network. Since such a management frame has been described above in detail, a description thereof will be omitted.

At step S113, the getting-on information that is determined to be valid is transmitted to the getting-on information transfer device.

A process that is performed in the getting-on information collection device according to an embodiment of the present invention will be described with reference to FIG. 8. FIG. 8 is a flowchart illustrating a method that is performed in the getting-on information collection device according to an embodiment of the present invention.

First, getting-on information transmitted by the getting-on information transfer device is received at step S121. In this case, the getting-on information is information that is read by the getting-on information transfer device. Furthermore, the getting-on information may be stored in a separate database or the server of a traffic information system. The getting-on information stored as described above may be used to manage bus getting-on information for each bus route or each time later. Once the getting-on information has been received, control is transferred to step S122.

Thereafter, a bus expected to arrive is identified and transmission information is generated at step S122. In this case, the bus expected to arrive is a bus having the earliest expected arrival time at a bus stop, as described above. The identification of the bus expected to arrive, which is performed at step S122, may be performed based on information about buses that will arrive at the bus stop, as described above. Thereafter, transmission information to be transmitted to the bus expected to arrive is generated at step S122. In this case, the transmission information includes the number of persons who will get on at the bus stop, information about the destinations of the persons, and the ID of the bus stop, as described above. Furthermore, the number of persons who will get on included in the transmission information may be determined based on the number of pieces of getting-on information collected at the bus stop. If the transmission information is generated at step S122, control is transferred to step S123.

The transmission information that is generated at step S122 is transmitted to the getting-on information notification device of the bus expected to arrive at step S123.

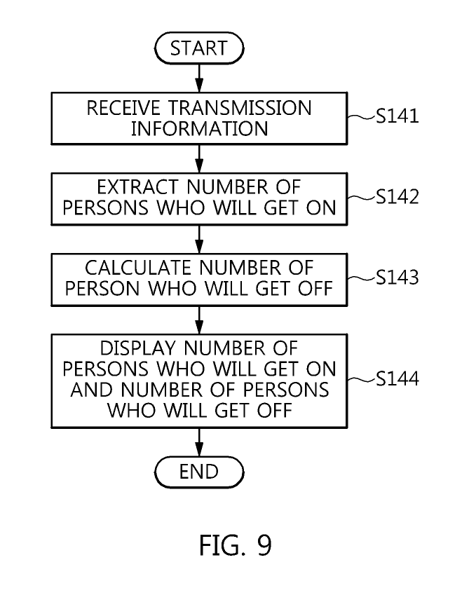

A process that is performed in the getting-on information notification device according to an embodiment of the present invention will be described with reference to FIG. 9. FIG. 9 is a flowchart illustrating a method that is performed in the getting-on information notification device according to an embodiment of the present invention.

First, transmission information transmitted by the getting-on information collection device is received at step S141.

Thereafter, the number of persons who will get on at a bus stop is extracted at step S142. At step S142, the number of persons who will get on at the bus stop is extracted based on the transmission information received at step S141. In this case, since the transmission information includes the number of persons who will get on, as described above, a separate calculation process is not required at step S142. Thereafter, control is transferred to step S143.

The number of persons who will get off at the bus stop is calculated at step S143. The calculation of the number of persons who will get off is performed based on transmission information corresponding to a plurality of bus stops that the bus expected to arrive has passed before arriving at the bus stop. Once this calculation step has been completed, control is transferred to step S144.

At step S144, a driver is informed of the number of persons who will get on or off calculated at steps S142 and S143. As described above, a display and a voice may be used as means for informing.

The present invention is advantageous in that a passenger can safely get on or off a bus because a bus driver can determine whether there is a person who will get on or off at each bus stop even when a user does not take a separate action to get on or off the bus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A getting-on information collection device, comprising:
a getting-on information reception unit configured to receive getting-on information entered by a mobile terminal of a passenger who desires to get on a bus at a bus stop via a getting-on information transfer device of the bus stop;
an arrival-expected bus identification unit configured to identify a bus expected to arrive having an earliest expected arrival time at the bus stop based on a bus number included in the getting-on information, and to generate transmission information to be transmitted to the bus expected to arrive; and
a transmission information transmission unit configured to transmit the transmission information to a getting-on information notification device of the bus expected to arrive.

2. The getting-on information collection device of claim 1, wherein the getting-on information notification device calculates a number of passengers who will get off at the bus stop based on transmission information corresponding to a plurality of bus stops that the bus has passed before arriving at the bus stop.

3. The getting-on information collection device of claim 1, wherein the arrival-expected bus identification unit calculates a number of passengers who will get on at the bus stop based on getting-on information of passengers received from the getting-on information transfer device.

4. The getting-on information collection device of claim 1, wherein the mobile terminal, if a size of the getting-on information is equal to or smaller than preset bytes, includes the getting-on information in a management frame used to set up communication, and then transmits the management frame to the getting-on information transfer device.

5. The getting-on information collection device of claim 4, wherein the management frame includes a Media Access Control (MAC) header, a frame body including the getting-on information, a Frame Check Sequence (FCS) and Cyclic Redundancy Check (CRC).

6. The getting-on information collection device of claim 1, wherein the transmission information includes a number of passengers who will get on at the bus stop, information about destinations of the passengers, and an ID of the bus stop.

7. The getting-on information collection device of claim 1, wherein the getting-on information notification device informs a bus driver of a number of persons who will get on or off at the bus stop based on the transmission information.

8. A getting-on information notification device, comprising:
a transmission information reception unit configured to receive a plurality of pieces of transmission information of a plurality of bus stops generated by a getting-on information collection device based on getting-on information entered by mobile terminals of passengers;
a number-of-changing passengers calculation unit configured to calculate a number of passengers who will get on or off at a bus stop having an earliest expected arrival time among the plurality of bus stops based on the plurality of pieces of transmission information; and
a number-of-changing passengers display unit configured to the number of passengers who will get on or off.

9. The getting-on information notification device of claim 8, wherein the number-of-changing passengers calculation unit classifies destination information of passengers included in the plurality of pieces of transmission information, and calculates a number of passengers who will get off at each of the plurality of bus stops.

10. The getting-on information notification device of claim 8, wherein the plurality of pieces of transmission information include numbers of passengers who will get on at the plurality of bus stops, destination information of the passengers, and IDs of the plurality of bus stops.

11. The getting-on information notification device of claim 8, wherein the number-of-changing passengers display unit includes at least one of a display and a speaker.

12. A mobile terminal, comprising;
an input unit configured to receive getting-on information including a bus number of a bus that a user will get on and destination information from the user;
a validity determination unit configured to determine whether the getting-on information is valid; and
a terminal communication unit configured to transmit the getting-on information to a getting-on information transfer device of a bus stop.

13. The mobile terminal of claim 12, wherein:
the validity determination unit includes the getting-on information in a management frame used to set up communication if a size of the getting-on information is equal to or smaller than preset bytes; and
the terminal communication unit transmits the management frame to the getting-on information transfer device.

14. The mobile terminal of claim 12, wherein the management frame includes an MAC header, a frame body including the getting-on information, a Frame Check Sequence (FCS) and Cyclic Redundancy Check (CRC).

15. The mobile terminal of claim 12, wherein the validity determination unit determines whether the getting-on information is valid by checking whether the destination information is present in bus route information of the bus number.

16. The mobile terminal of claim 12, wherein the validity determination unit, if the getting-on information is not valid, requests the user to enter getting-on information again.
